(19) United States
(12) Patent Application Publication
(10) Pub. No.: US 2006/0245907 A1
(43) Pub. Date: Nov. 2, 2006

(54) Fork assembly for a pallet truck

(76) Inventor: Wen-Ching Lee, Taipei Hsien (TW)

Correspondence Address: Rabin & Berdo, P.C., Suite 500, 1101 14th Street, Washington, DC, 20005, US

(21) Appl. No.: 11/115,378

(22) Filed: Apr. 27, 2005

(51) Int. Cl. B66C 3/00

(52) U.S. Cl. 414/785

(57) ABSTRACT

A pallet truck includes an assembly plate adapted to be firmly engaged with the pallet truck body and having a plane, a pair of elongated first assembly holes defined through the plane, a wing obliquely extending from a side of the plane and an auxiliary plate extending from a side of the plane and opposed to the wing and having an L-shaped cross section, a pair of forks each having a side hole defined in a side of the fork to align with a corresponding one of the second assembly holes of the assembly plate and two through holes to align with a corresponding one of the two first assembly holes and securing devices respectively to secure engagement between the assembly plate and the two forks.

### BACKGROUND OF THE INVENTION

1. Field of the Invention

The present invention relates to a fork assembly, and more particularly to a fork assembly that is able to be dismantled from a pallet truck.

2. Description of Related Art

A conventional pallet truck, as shown in FIG. 4, is used to lift pallets respectively having goods stored thereon by the forks being driven under the pallet, then raised slightly until the pallet is clear of the ground and can be driven away. However, in the normal course of use, the forks (41) firmly connected to the pallet truck body (4) are easily damaged and sometimes broken. Because the forks of the pallet truck are welded on the pallet truck body, dismantling of the forks for repair is not possible. Therefore, the user always replace the complete set of forks instead of only the damaged fork. That is, if there is only one damaged fork, the user has no choice but to change the entire pair of forks due to the assembly method between the pallet truck body and the forks. Dismantling the entire pair of forks without consideration of the serviceable one is labor intensive and not cost effective.

To overcome the shortcomings, the present invention tends to provide an improved fork assembly for a pallet truck to mitigate the aforementioned problems.

### SUMMARY OF THE INVENTION

The primary objective of the present invention is to provide a fork assembly which can be disassembled from the pallet truck so that the user is able to dismantle only a damaged fork without replacing the entire pair of forks so as to be efficient and economic.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the pallet truck of the present invention;

FIG. 2 is an exploded perspective view showing that the fork assembly is disassembled from the pallet body;

FIG. 3 is a schematic cross sectional view showing engagement between the assembly plate and the fork; and

FIG. 4 is a perspective view of a conventional pallet truck.

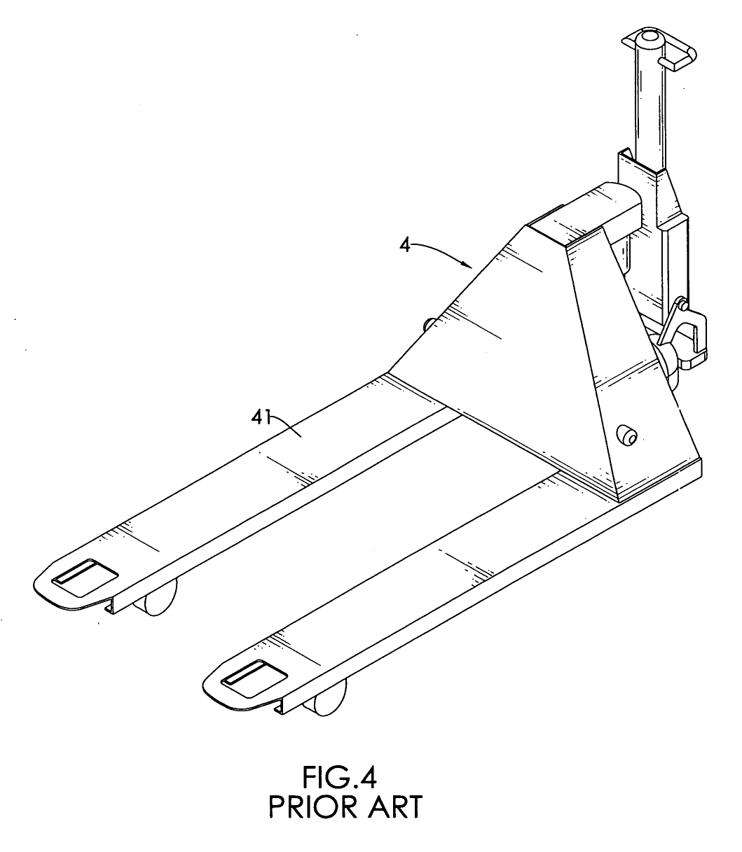

### DETAILED DESCRIPTION OF THE PREFERRED EMBODIMENT

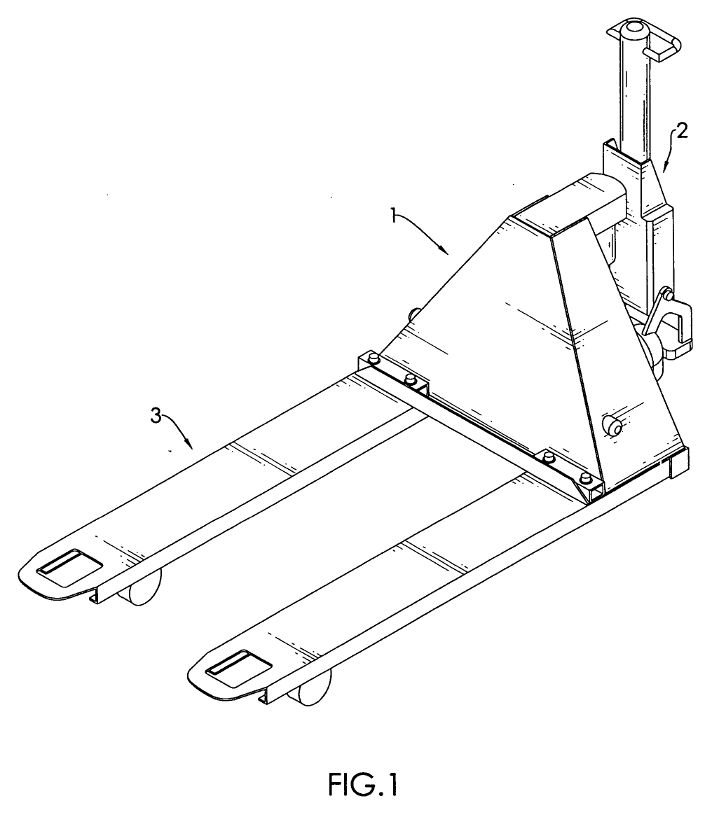

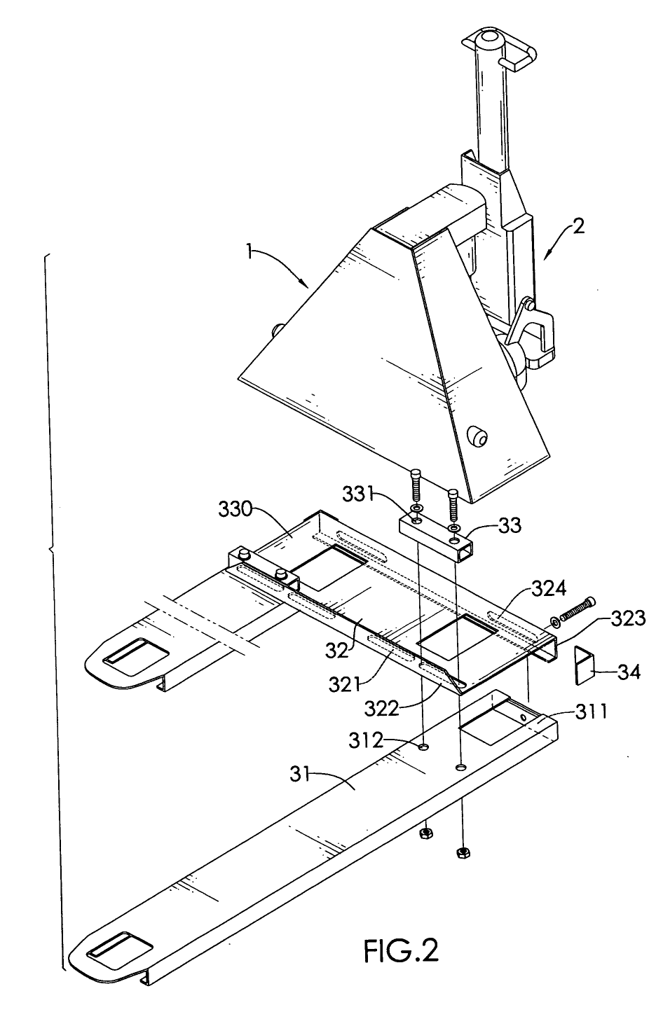

With reference to FIGS. 1 and 2, it is noted that the pallet truck in accordance with the present invention includes a pallet truck body (1), a hydraulic system (2) provided on a side of the pallet truck body (1) and a fork assembly (3) securely connected to the pallet truck body (1) and opposite to the hydraulic system (2). Because the pallet truck body (1) and the hydraulic system (2) are conventional in the art and the functions thereof are not the focus of the invention, the following discussion will be aimed at the structure of the fork assembly (3).

The fork assembly (3) includes a pair of forks (31), an assembly plate (32) and a pair of assembly blocks (33). Each fork (31) has a metal plate (311) with a threaded hole defined in a side of the plate (311) and two through holes (312) defined through a top face of the fork. The assembly plate (32) is provided to horizontally interconnect the two forks (31) and has a plane (320), two elongated first assembly holes (321) defined through a top face of the plane (320) to respectively correspond to the two through holes (312) of the fork (31), a wing (322) obliquely extending from a side of the plane (320), an auxiliary plate (323) having an L-shaped cross section and a vertical section through which two elongated second assembly holes (324) are defined therethrough to respectively correspond to the threaded hole of the plate (311) of the two forks (31) and a horizontal section extending from an edge of the vertical section of the auxiliary plate (323). Each assembly block (33) has two holes (331) defined through the assembly block (33) to correspond to the two through holes (312) of the fork (31). Further, an L-shaped reinforcing plate (34) is provided between the vertical section and the horizontal section to reinforce the integrity of the assembly plate (32).

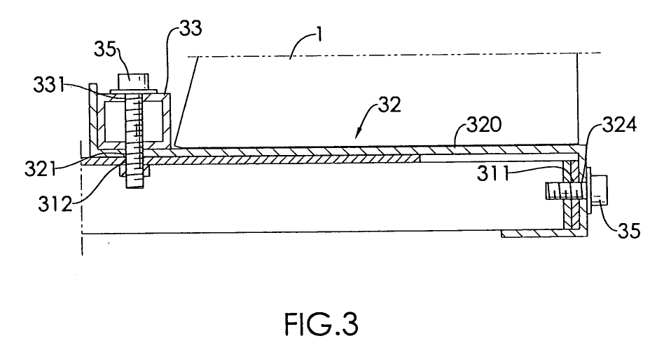

With reference to FIG. 3, when the fork assembly of the present invention is to be assembled to the pallet truck body (1), the assembly plate (32) is first welded to the bottom of the pallet truck body (1) without blocking the first assembly holes (321). Then after alignment between the first assembly holes (321) and the through holes (312) and between the threaded holes of the plates (311) and the second assembly hole (324) are accomplished, a securing device (35) such as a bolt is employed to secure the engagement between the assembly plate (32) and the two forks (31). To enhance the engagement between the assembly plate (32) and the forks (31), the assembly blocks (33) are applied to have the two holes (331) of each assembly block (33) aligned with the first assembly holes (321) which in turn are aligned with the through holes (312) of the fork (31). Then the securing device (35) is applied to extend through and secure engagement among the assembly block (33), the assembly plate (32) and the fork (31).

With the ability to be assembled and disassembled, the user is able to replace the damaged fork only and thus cost for repair is effective.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a pallet truck having a pallet truck body and a hydraulic device mounted on a side of the pallet truck body and a fork assembly connected to the pallet truck body and opposite to the hydraulic device, wherein the improvements comprise:
the fork assembly including:
an assembly plate adapted to be firmly engaged with a bottom face of the pallet truck body and having a plane, a pair of elongated first assembly holes defined through the plane, a wing obliquely extending from a side of the plane and an auxiliary plate extending from a side of the plane and opposed to the wing and having an L-shaped cross section so as to have a vertical section through which a pair of elongated second assembly holes are defined and a horizontal section extending from a side of the vertical section;
a pair of forks each having two through holes to align with a corresponding one of the two first assembly holes; and
securing devices respectively extending through the alignment between the respective fork's first assembly hole and the through holes to secure engagement between the assembly plate and the two forks.

2. The pallet truck as claimed in claim 1, wherein a reinforcing plate is provided between the vertical section and the horizontal section to reinforce integrity of the assembly plate.

3. The pallet truck as claimed in claim 1 further comprising two assembly blocks each having two holes to correspond to one of the two first assembly holes of the assembly plate as well as the two through holes of each one of the two forks so that after extension of the securing device through the holes of the assembly block, the first assembly hole of the assembly plate and the through holes of each of the forks, engagement among the assembly block, the assembly plate and each of the forks is secured.

4. The pallet truck as claimed in claim 2 further comprising two assembly blocks each having two holes to correspond to one of the two first assembly holes of the assembly plate as well as the two through holes of each of the forks so that after extension of the securing device through the holes of the assembly block, the first assembly hole of the assembly plate and the through holes of each of the forks, engagement among the assembly block, the assembly plate and each of the forks is secured.

5. The pallet truck as claimed in claim 4, wherein each fork has a plate formed on a side of the fork and having a threaded hole to align with a corresponding one of the second assembly holes of the assembly plate and one of the securing devices is able to extend between the second assembly hole and the threaded hole to secure engagement between the forks and the assembly plate.
